(19) United States
(12) Patent Application Publication
(10) Pub. No.: US 2026/0264686 A1
(43) Pub. Date: Sep. 10, 2026

(54) VEHICLE TRAVEL CONTROL APPARATUS

(71) Applicants: TOYOTA JIDOSHA KABUSHIKI KAISHA, Aichi (JP); DENSO CORPORATION, Aichi-pref. (JP)

(72) Inventor: Ichiro AIZAWA, Toyota-shi (JP)

(21) Appl. No.: 19/551,603

(22) Filed: Feb. 27, 2026

(30) Foreign Application Priority Data
Mar. 5, 2025 (JP) 2025-034703

(51) Int. Cl. B60W 30/18; B60W 30/14

(52) U.S. Cl. CPC B60W 30/18159; B60W 30/143; B60W 2510/20; B60W 2520/10; B60W 2552/10; B60W 2720/10

(57) ABSTRACT

A vehicle travel control apparatus includes an electronic control unit configured to determine, based on road information acquired by a road information acquisition device, a target vehicle speed in accordance with a road on which a vehicle is traveling, and to control a vehicle speed of the vehicle so that the vehicle speed becomes the determined target vehicle speed. When the vehicle is traveling through a roundabout and is determined, based at least on object information acquired by an object information acquisition device, to be oriented toward a radial road connected to a circulatory roadway of the roundabout, the electronic control unit determines a target planned vehicle speed in accordance with the radial road and executes transition vehicle speed control for controlling the vehicle speed of the vehicle such that the vehicle speed gradually approaches the target planned vehicle speed.

### CROSS-REFERENCE TO RELATED APPLICATION

This application claims priority to Japanese Patent Application No. JP 2025-034703 filed on Mar. 5, 2025, the content of which is hereby incorporated by reference in its entirety into this application.

### BACKGROUND

### 1. Technical Field

The present disclosure relates to a travel control apparatus for a vehicle such as an automobile, and more particularly to a travel control apparatus for controlling a vehicle speed when a vehicle travels through a roundabout (circular intersection).

### 2. Description of the Related Art

As one type of travel control apparatus for a vehicle such as an automobile, there is known a travel control apparatus that determines a target vehicle speed in accordance with a road on which the vehicle is traveling and a traveling situation, and controls a vehicle speed so that the vehicle speed becomes the target vehicle speed.

For example, Japanese Laid-open Patent Publication No. 2017-88161 discloses a travel control apparatus that, when a vehicle is traveling through a roundabout, estimates a position of the vehicle based on a steering angle detected by a sensor, a yaw rate of the vehicle and a vehicle speed, and determines whether or not the vehicle is exiting from the roundabout. When the travel control apparatus determines that the vehicle is exiting from the roundabout, the travel control apparatus accelerates the vehicle to increase the vehicle speed.

According to this type of travel control apparatus, when the vehicle exits from a roundabout to a radial road, the vehicle is automatically accelerated so that the vehicle speed increases. Therefore, it is possible to assist driving of a driver when the vehicle exits from the roundabout to the radial road.

In the conventional travel control apparatus described in the above publication, a position of a vehicle in a roundabout is estimated based on a steering angle, a yaw rate of the vehicle and a vehicle speed, and it is determined whether or not the vehicle is exiting from the roundabout.

However, when the vehicle is traveling through the roundabout, steering operations and acceleration/deceleration operations may be performed to change a positional relationship between the own vehicle and another vehicle, or to change the position of the own vehicle in a width direction of a circulatory roadway. Therefore, a steering angle, a yaw rate of the vehicle and a vehicle speed may take values different from those when the vehicle is traveling around the circulatory roadway at a constant speed. In addition, in a roundabout whose circulatory roadway is not circular, such as an ellipse or an oval, the steering angle and the yaw rate of the vehicle fluctuate even when the vehicle is traveling around the circulatory roadway along the circulatory roadway. Accordingly, in the conventional travel control apparatus, even when the vehicle is not exiting from the roundabout, the vehicle may be erroneously determined to be exiting from the roundabout, and the vehicle may be unnecessarily accelerated.

### SUMMARY

The present disclosure provides an improved travel control apparatus capable of reducing a possibility that a vehicle is erroneously determined to be exiting from a roundabout and a possibility that a vehicle speed during exiting from the roundabout is inappropriately controlled.

According to the present disclosure, there is provided a vehicle travel control apparatus comprising: a road information acquisition device configured to acquire information on a road on which a vehicle is traveling; and an electronic control unit configured to determine, based on road information acquired by the road information acquisition device, a target vehicle speed in accordance with the road on which the vehicle is traveling, and to control a vehicle speed of the vehicle so that the vehicle speed becomes the determined target vehicle speed.

The vehicle travel control apparatus further comprises an object information acquisition device configured to acquire object information around the vehicle. The electronic control unit is configured such that, when the vehicle is traveling through a roundabout and is determined, based at least on object information acquired by the object information acquisition device, to be oriented toward a radial road connected to a circulatory roadway of the roundabout, the electronic control unit determines a target planned vehicle speed in accordance with the radial road and executes transition vehicle speed control for controlling the vehicle speed of the vehicle such that the vehicle speed gradually approaches the target planned vehicle speed.

According to the above travel control apparatus, when the vehicle is traveling through a roundabout and is determined, based at least on object information acquired by the object information acquisition device, to be oriented toward a radial road connected to a circulatory roadway of the roundabout, a transition vehicle speed control is executed. In the transition vehicle speed control, a target planned vehicle speed in accordance with the radial road is determined, and a vehicle speed is controlled so that the vehicle speed gradually approaches the target planned vehicle speed.

Accordingly, as compared with a conventional case in which it is determined whether or not the vehicle is exiting from the roundabout based on a steering angle, a yaw rate of the vehicle and the like, it is possible to reduce the likelihood that exiting from the roundabout is erroneously determined and that inappropriate transition vehicle speed control is performed.

In one aspect of the present disclosure, the electronic control unit is configured to determine that the vehicle is oriented toward a radial road when the radial road exists in front of the vehicle and an angle formed between a straight-ahead direction of the vehicle and a direction along the radial road is equal to or smaller than a reference angle.

According to the above aspect, when a radial road exists in front of the vehicle and an angle formed between a straight-ahead direction of the vehicle and a direction along the radial road is equal to or smaller than the reference angle, the vehicle is determined to be oriented toward the radial road.

Accordingly, as compared to where only one of the following conditions is used as a determination condition: that a radial road exists in front of the vehicle, and that the angle formed between the straight-ahead direction of the vehicle and the direction along the radial road is equal to or smaller than the reference angle, it is possible to accurately determine whether or not the vehicle is oriented toward the radial road.

In another aspect of the present disclosure, the electronic control unit is configured to determine that the vehicle is oriented toward a radial road when the radial road exists in front of the vehicle, the angle formed between the straight-ahead direction of the vehicle and the direction along the radial road is equal to or smaller than the reference angle, and a steering angle is equal to or greater than a reference steering angle toward a side of the radial road.

According to the above aspect, in addition to the fact that the radial road exists in front of the vehicle and the angle formed between the straight-ahead direction of the vehicle and the direction along the radial road is equal to or smaller than the reference angle, when the steering angle is equal to or greater than the reference steering angle toward the side of the radial road, the vehicle is determined to be oriented toward the radial road.

Accordingly, as compared to where the fact that the steering angle is equal to or greater than the reference steering angle toward the side of the radial road is not taken into consideration, it is possible to accurately determine whether or not the vehicle is oriented toward the radial road, and to reduce the likelihood that exiting from the roundabout is erroneously determined and that inappropriate transition vehicle speed control is performed.

In still another aspect of the present disclosure, the electronic control unit is configured such that, even when the electronic control unit determines that the vehicle is oriented toward the radial road, if a width of the circulatory roadway is equal to or greater than a width of two lanes and the vehicle is not traveling in a region corresponding to a width of an outermost one lane of the circulatory roadway, the transition vehicle speed control is not executed.

Even when the vehicle is oriented toward the radial road, if the width of the circulatory roadway is equal to or greater than the width of two lanes and the vehicle is not traveling in the region corresponding to the width of the outermost one lane of the circulatory roadway, it can be considered that a driver is attempting not to cause the vehicle to exit from the roundabout, but to move the vehicle to an outer region of the circulatory roadway.

According to the above aspect, even when it is determined that the vehicle is oriented toward the radial road, if the width of the circulatory roadway is equal to or greater than the width of two lanes and the vehicle is not traveling in the region corresponding to the width of the outermost one lane of the circulatory roadway, the transition vehicle speed control is not executed. Therefore, it is possible to prevent unnecessary transition vehicle speed control from being executed and the vehicle speed from being inappropriately controlled.

In still another aspect of the present disclosure, the electronic control unit is configured such that, when a width of the circulatory roadway is equal to or greater than a width of two lanes, the transition vehicle speed control is executed when the electronic control unit determines that the vehicle is oriented toward the radial road and a distance between the vehicle and an exit to the radial road is equal to or smaller than a reference distance.

When the vehicle exits from a roundabout in which a width of the circulatory roadway is equal to or greater than a width of two lanes, not only does the vehicle become oriented toward a radial road, but also the vehicle approaches an exit to the radial road, so that a distance between the vehicle and the exit to the radial road decreases.

According to the above aspect, the transition vehicle speed control is executed when the vehicle is oriented toward the radial road and the distance between the vehicle and the exit to the radial road is equal to or smaller than the reference distance. Therefore, as compared to where the distance between the vehicle and the exit to the radial road is not taken into consideration, it is possible to accurately determine whether or not the vehicle exits from the roundabout, and to reduce the likelihood that exiting from the roundabout is erroneously determined and that inappropriate transition vehicle speed control is performed.

Other objects, features and attendant advantages of the present disclosure will be readily understood from the description of embodiments of the present disclosure given below with reference to the accompanying drawings.

### BRIEF DESCRIPTION OF THE DRAWINGS

FIG. 1 is a schematic configuration diagram showing an embodiment of a vehicle travel control apparatus according to the present disclosure.

FIG. 2 is a flowchart corresponding to a travel control program according to a first embodiment.

FIG. 3 is a flowchart corresponding to a travel control program according to a second embodimen.

FIG. 4 is a diagram for explaining operation of the first embodiment, illustrating a situation in which a vehicle travels through a roundabout having a small circulatory roadway width in a country with right-hand traffic.

FIG. 5 is a diagram for explaining operation of the first embodiment, illustrating a situation in which a vehicle travels through a roundabout having a large circulatory roadway width in a country with right-hand traffic.

FIG. 6 is a diagram for explaining operation of the second embodiment, illustrating a situation in which a vehicle travels through a roundabout having a large circulatory roadway width in a country with right-hand traffic.

### DETAILED DESCRIPTION

Hereinafter, a vehicle travel control apparatus according to embodiments of the present disclosure will be described in detail with reference to the accompanying drawings.

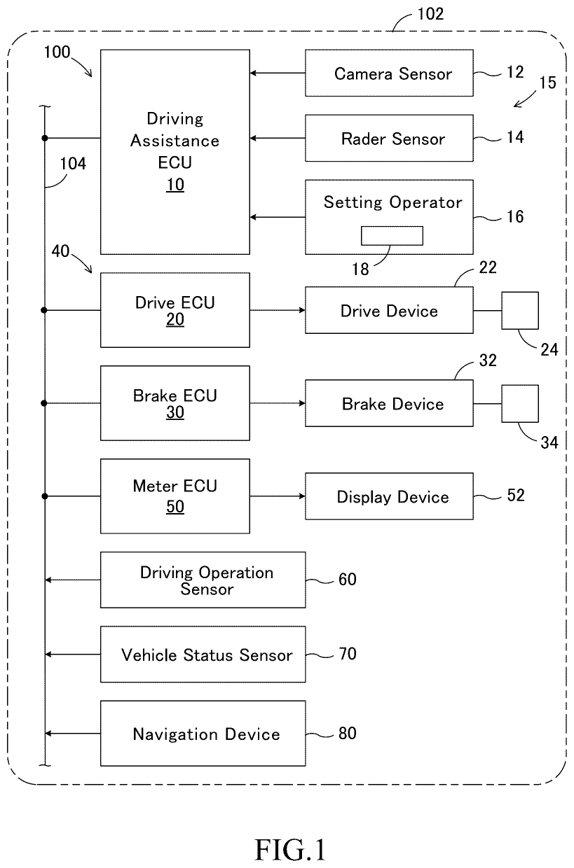

As shown in FIG. 1, a travel control apparatus 100 according to an embodiment of the present disclosure is applied to a vehicle 102 and includes a driving assistance ECU 10. The vehicle 102 may be a vehicle capable of autonomous driving and is provided with a drive ECU 20, a brake ECU 30 and a meter ECU 50. The ECU refers to an electronic control unit including a microcomputer as a main component.

The microcomputer of each ECU includes a CPU, a ROM, a RAM, a readable and writable nonvolatile memory (N/M) and an interface (I/F), and the like. The CPU implements various functions by executing instructions (programs, routines) stored in the ROM. Furthermore, these ECUs are connected to each other so as to be capable of data exchange (communication) via a CAN (Controller Area Network) 104. Accordingly, detection values of sensors (including switches) connected to a particular ECU are transmitted to other ECUs as well.

The driving assistance ECU 10 is a central control unit that performs driving assistance travel control such as following-distance control (radar cruise control (RCC)) and deceleration assistance control. In the embodiment, the driving assistance ECU 10 cooperates with other ECUs to execute following-distance control, as will be described in detail later. The following-distance control is abbreviated as RCC.

A camera sensor 12, a radar sensor 14 and a setting operator 16 are connected to the driving assistance ECU 10. The camera sensor 12 and the radar sensor 14 each include a plurality of camera devices and a plurality of radar devices, respectively. The camera sensor 12 and the radar sensor 14 function as an object information acquisition device 15 that acquires object information around the vehicle 102.

Each camera device of the camera sensor 12 includes, although not shown in the drawings, a camera unit that images surroundings of the vehicle 102, and a recognition unit that analyzes image data obtained by imaging by the camera unit and recognizes lane markings, road boundaries, other vehicles and other objects. The recognition unit supplies information on recognized objects to the driving assistance ECU 10 at predetermined time intervals.

Each radar device of the radar sensor 14 uses radio waves in a millimeter-wave band to detect a distance between the own vehicle and a solid object, a relative speed between the own vehicle and the solid object, and a relative position (direction) of the solid object with respect to the own vehicle, and supplies information representing these to the driving assistance ECU 10 at predetermined time intervals. Note that, instead of the radar sensor 14 or in addition to the radar sensor 14, a LiDAR (Light Detection And Ranging) may be used.

The setting operator 16 is provided at a position operable by a driver, such as on a steering wheel (not shown in FIG. 1), and is configured to be operated by the driver. The setting operator 16 includes an RCC switch 18. The RCC switch 18 includes a main switch, a distance-setting switch, a resume switch, a cancel switch and the like.

The main switch is a switch for starting RCC. The distance-setting switch is a switch for setting a target inter-vehicle distance Lvt relative to a preceding vehicle. The resume switch is a switch for resuming RCC when RCC has been temporarily interrupted because a braking operation or a driving operation is performed by the driver during RCC. The cancel switch is a switch for terminating RCC. The target inter-vehicle distance Lvt can be set to a plurality of values, for example three values of large, medium and small, and may be variably set in accordance with the vehicle speed V so as to become smaller as the vehicle speed decreases.

A drive device 22 that accelerates the vehicle 102 by applying a driving force to drive wheels 24 is connected to the drive ECU 20. The drive ECU 20, during normal operation, controls the drive device 22 such that a driving force generated by the drive device 22 changes in accordance with a driving operation by the driver. When a command signal is received from the driving assistance ECU 10, the drive ECU 20 controls the drive device 22 based on the command signal.

A brake device 32 that decelerates the vehicle 102 by applying a braking force to wheels 34 is connected to the brake ECU 30. The brake ECU 30, during normal operation, controls the brake device 32 such that a braking force generated by the brake device 32 changes in accordance with a braking operation by the driver. When a command signal is received from the driving assistance ECU 10, the brake ECU 30 performs automatic braking by controlling the brake device 32 based on the command signal. Note that the wheels 34 include the drive wheels 24.

Accordingly, the drive ECU 20, the drive device 22, the brake ECU 30 and the brake device 32 cooperate with each other to function as a driving/braking force control device 40 that controls a driving/braking force of the vehicle 102. Note that, even when a braking force is automatically applied to the wheels by the driving/braking force control device 40, brake lamps (not shown in FIG. 1) are turned on.

A display device 52 for displaying a state of the control by the driving assistance ECU 10 and the like is connected to the meter ECU 50. The display device 52 may be, for example, a multi-information display on which meters and various information are displayed, or may be a display of a navigation device. The display device 52 may, upon receiving a signal from the driving assistance ECU 10, display a state of the control such as RCC.

A driving operation sensor 60 and a vehicle state sensor 70 are also connected to the CAN 104. Information (referred to as sensor information) detected by the driving operation sensor 60 and the vehicle state sensor 70 is transmitted to the CAN 104. The sensor information transmitted to the CAN 104 is available to each ECU as appropriate. Note that the sensor information may be information from sensors connected to a particular ECU and transmitted from that particular ECU to the CAN 104.

The driving operation sensor 60 includes a driving operation amount sensor that detects an operation amount of an accelerator pedal, a braking operation amount sensor that detects a master cylinder pressure or a pedal force on a brake pedal, and a brake switch that detects whether or not the brake pedal is operated. The driving operation sensor 60 further includes a steering angle sensor that detects a steering angle θ, a steering torque sensor that detects a steering torque, and the like.

The vehicle state sensor 70 includes a vehicle speed sensor that detects a vehicle speed V of the vehicle 102, a longitudinal acceleration sensor that detects an acceleration in a longitudinal direction of the vehicle, a lateral acceleration sensor that detects an acceleration in a lateral direction of the vehicle, and a yaw rate sensor that detects a yaw rate of the vehicle, and the like.

Furthermore, a navigation device 80 is also connected to the CAN 104. The navigation device 80 includes a GPS receiver that detects a position of the vehicle 102, a storage device that stores map information and road information, and a communication device that acquires latest map information and road information from outside. Therefore, the navigation device 80 functions as a road information acquisition device that acquires information on a road along which the vehicle 102 travels. In particular, the road information includes information on a location of a roundabout and a radius of a lane center of a circulatory roadway of the roundabout. Note that the camera sensor 12 may also function as a road information acquisition device.

When the main switch of the RCC switch 18 is turned on, the driving assistance ECU 10 starts RCC, and when the cancel switch is operated, the driving assistance ECU 10 terminates RCC. In RCC, a target vehicle speed Vnt in accordance with a road on which the vehicle is traveling is determined based on road information acquired by the road information acquisition device, and the vehicle speed V of the vehicle is controlled so that the vehicle speed becomes the target vehicle speed. Also, even when the main switch is on, if a driving/braking operation is performed by the driver, the driving assistance ECU 10 terminates RCC. When the driving/braking operation is terminated and the resume switch is operated, RCC is resumed.

When there is a preceding vehicle (following target vehicle) ahead of the own vehicle 102 while RCC is being executed, the driving/braking force is automatically controlled such that, without requiring a driving/braking operation by the driver, an inter-vehicle distance Lv between the own vehicle and the preceding vehicle becomes a target inter-vehicle distance Lvt and the own vehicle travels following the preceding vehicle. When there is no preceding vehicle ahead of the own vehicle 102 while RCC is being executed, the driving/braking force is automatically controlled such that the vehicle speed V of the own vehicle becomes the target vehicle speed Vnt in accordance with the road.

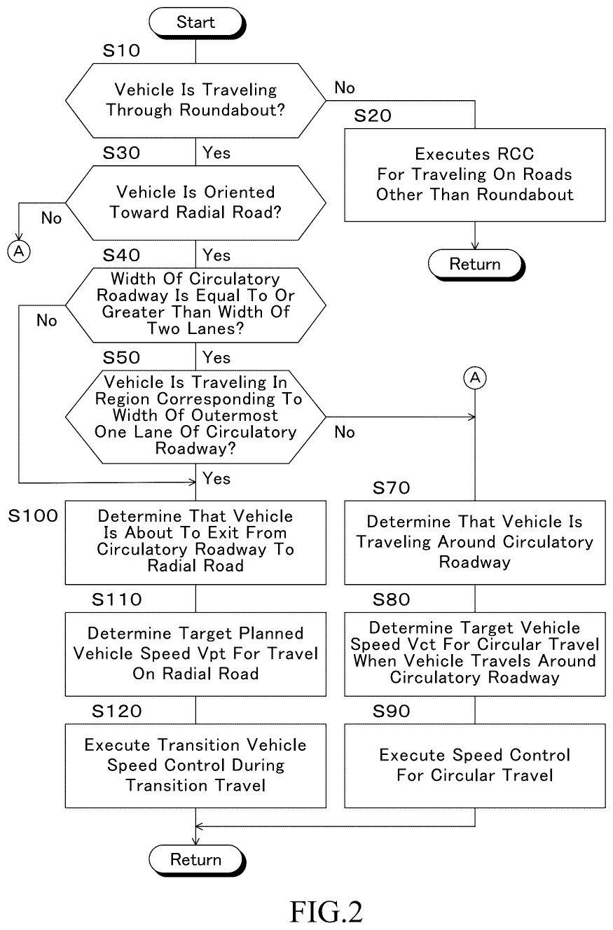

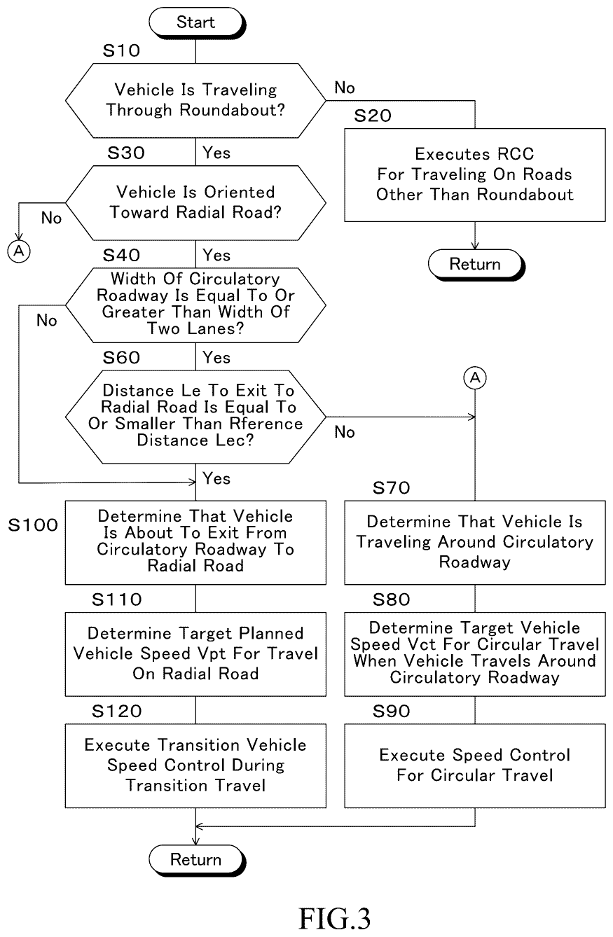

In a first embodiment described later, a ROM of the driving assistance ECU 10 stores a travel control program corresponding to the flowchart shown in FIG. 2. In a second embodiment, the ROM of the driving assistance ECU 10 stores a travel control program corresponding to the flowchart shown in FIG. 3.

[First Embodiment] Next, travel control according to the first embodiment will be described with reference to the flowchart shown in FIG. 2. The travel control according to the flowchart shown in FIG. 2 is repeatedly executed at predetermined time intervals by the CPU of the driving assistance ECU 10 in a state where the main switch of the RCC switch 18 is on.

First, in step S10, the CPU determines whether or not the vehicle is traveling through a roundabout based on information acquired by the road information acquisition device, for example information on a position of the vehicle 102 on a map detected by the navigation device 80. When an affirmative determination is made, the process proceeds to step S30, and when a negative determination is made, the process proceeds to step S20.

In step S20, the CPU executes RCC for traveling on roads other than the roundabout. RCC in this step may be executed in any known manner in the art. For example, a target vehicle speed Vnt is set in accordance with a road on which the vehicle 102 is traveling, and the driving/braking force is automatically controlled so that the vehicle speed V becomes the target vehicle speed Vnt.

It should be noted that, in step S20 and in steps S90 and S120 described later, when there is a preceding vehicle ahead of the own vehicle 102, the driving/braking force is automatically controlled such that an inter-vehicle distance Lv between the own vehicle and the preceding vehicle becomes the target inter-vehicle distance Lvt and the own vehicle travels following the preceding vehicle.

In step S30, the CPU determines whether or not the vehicle 102 is oriented toward a radial road connected to a circulatory roadway of the roundabout based at least on object information acquired by the object information acquisition device 15. When a negative determination is made, the process proceeds to step S70, and when an affirmative determination is made, the process proceeds to step S40.

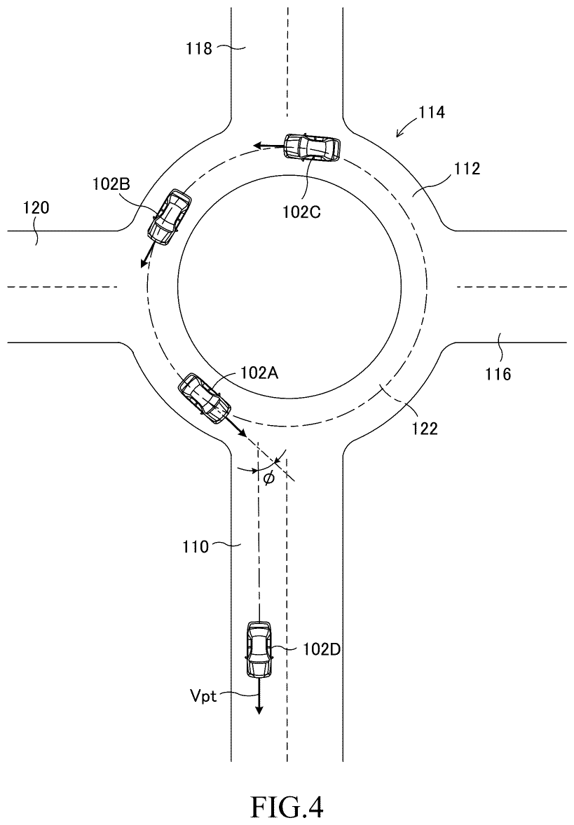

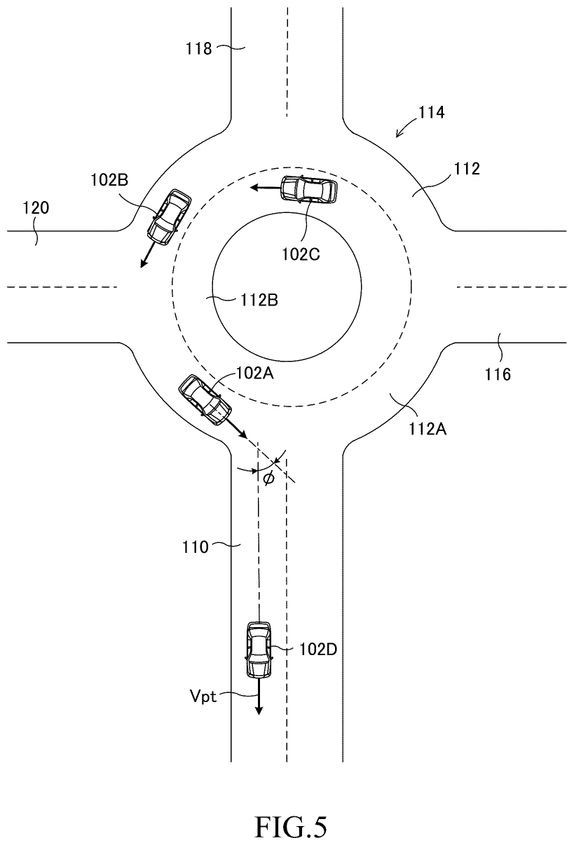

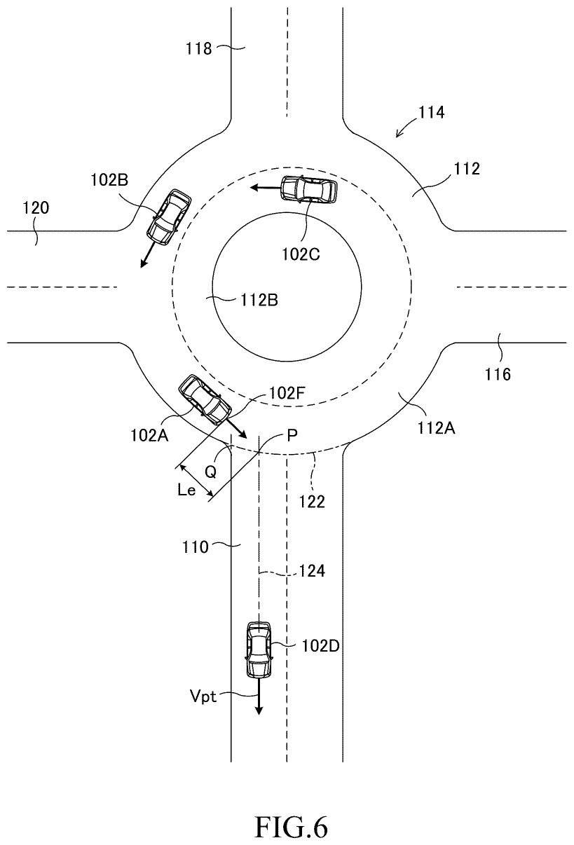

In this case, as shown in FIG. 4, when a radial road 110 exists in front of a vehicle 102A and an angle φ formed between a straight-ahead direction of the vehicle and a direction along the radial road is equal to or smaller than a reference angle φc (positive constant), it may be determined that the vehicle is oriented toward the radial road. In FIG. 4, reference numeral 112 denotes a circulatory roadway of a roundabout 114, and reference numerals 116 to 120 denote other radial roads connected to the circulatory roadway 112. Vehicles 102B and 102C are traveling around the circulatory roadway 112. A vehicle 102D is traveling on the radial road 110 at a vehicle speed Vpt (the same applies to FIGS. 5 and 6 described later).

Alternatively, it may be determined that the vehicle is oriented toward the radial road when a radial road exists in front of the vehicle, the angle φ formed between the straight-ahead direction of the vehicle and the direction along the radial road is equal to or smaller than the reference angle φc, and the steering angle θ is equal to or greater than a reference steering angle θc (positive constant) toward the side of the radial road (modified example).

In step S40, the CPU determines whether or not a width of the circulatory roadway is equal to or greater than a width of two lanes based on information from the navigation device 80 and/or information detected by the camera sensor 12. When a negative determination is made, the process proceeds to step S100, and when an affirmative determination is made, the process proceeds to step S50.

In step S50, the CPU determines whether or not the vehicle 102 is traveling in a region corresponding to a width of the outermost one lane of the circulatory roadway based on information detected by the camera sensor 12. When an affirmative determination is made, the process proceeds to step S100, and when a negative determination is made, the process proceeds to step S70.

FIG. 5 shows a roundabout 114 in which a width of the circulatory roadway is equal to a width of two lanes. In FIG. 5, vehicles 102A and 102B are traveling in a region 112A corresponding to the width of the outermost one lane of the circulatory roadway, and a vehicle 102C is traveling in a region 112B corresponding to the width of the inner one lane of the circulatory roadway.

In step S70, the CPU determines that the vehicle 102 is conducting circular travel around the circulatory roadway. The circular travel means that the vehicle travels along the circulatory roadway, and a travel range of the vehicle may be smaller than a range corresponding to one full lap around the circulatory roadway.

In step S80, the CPU determines a target vehicle speed Vct for circular travel when the vehicle travels around the circulatory roadway, based on a radius of the circulatory roadway or a road sign or road marking relating to a vehicle speed. The radius of the circulatory roadway may be estimated based on information from the navigation device 80, or may be estimated by estimating a curvature of the circulatory roadway based on information detected by the camera sensor 12, or may be estimated based on the steering angle θ.

In step S90, the CPU executes speed control for circular travel, in which speed control during circular travel is performed such that the vehicle speed V of the vehicle 102 becomes the target vehicle speed Vct for circular travel, by controlling the driving/braking force control device 40.

In step S100, the CPU determines that the vehicle 102 is ending circular travel around the circulatory roadway and is about to exit from the circulatory roadway to the radial road.

In step S110, the CPU determines a target planned vehicle speed Vpt when the vehicle travels on the radial road, based on information from the navigation device 80 or based on a road sign or road marking relating to the vehicle speed on the radial road.

In step S120, the CPU executes transition vehicle speed control during transition travel from the circulatory roadway to the radial road, in which the driving/braking force control device 40 is controlled so that the vehicle speed V of the vehicle 102 gradually approaches the target planned vehicle speed Vpt. Step S120 is repeatedly executed until the vehicle speed V becomes the target planned vehicle speed Vpt, and when the vehicle speed V becomes the target planned vehicle speed Vpt, this control is temporarily terminated and the transition vehicle speed control is completed.

[Second Embodiment]Next, travel control according to the second embodiment will be described with reference to the flowchart shown in FIG. 3. The travel control according to the flowchart shown in FIG. 3 is also repeatedly executed at predetermined time intervals by the CPU of the driving assistance ECU 10 in a state where the main switch of the RCC switch 18 is on.

As can be understood from comparison between FIG. 3 and FIG. 2, when an affirmative determination is made in step S40, step S60 is executed instead of step S50 in the first embodiment. Steps other than step S60 are executed in the same manner as in the first embodiment.

In step S60, the CPU determines whether or not a distance Le from a reference position of the vehicle 102 to an exit to the radial road is equal to or smaller than a reference distance Lec (positive constant), based on information detected by the camera sensor 12. When a negative determination is made, the process proceeds to step S70, and when an affirmative determination is made, the process proceeds to step S100.

FIG. 6 shows a situation in which a vehicle 102A is about to exit from a region 112A corresponding to the width of the outermost one lane of the circulatory roadway 112 to a radial road 110 in a roundabout 114 in which the width of the circulatory roadway 112 is equal to the width of two lanes.

As shown in FIG. 6, the reference position of the vehicle 102 may be, for example, a front-end center 102F of the vehicle. The exit to the radial road may be an intersection point P between an extension line 122 of an outer boundary of the circulatory roadway 112 and a virtual centerline 124 of a lane 110 of the radial road 110 which the vehicle is scheduled to travel. In FIG. 6, a distance Le is illustrated as a distance from the front-end center 102F to the intersection point P. Alternatively, the exit to the radial road may be an intersection point Q between the extension line 122 of the outer boundary of the circulatory roadway 112 and an extension line of a boundary of the radial road 110 on a side closer to the vehicle. Furthermore, the exit to the radial road may be set at a position other than the above intersection points P and Q.

[Operation of the Embodiments] Next, the operations of the first and second embodiments will be described with respect to a case where a vehicle travels around a circulatory roadway and a case where the vehicle exits from the circulatory roadway to a radial road.

### Case Where the Vehicle Travels Around the Circulatory Roadway

In both the first and second embodiments, an affirmative determination is made in step S10 and a negative determination is made in step S30. Accordingly, steps S70 to S90 are performed such that the target vehicle speed Vct in accordance with the circulatory roadway is set and speed control during circular travel is executed so that the vehicle speed V of the vehicle 102 becomes the target vehicle speed Vct.

<Case Where the Width of the Circulatory Roadway Is Equal to the Width of One Lane and the Vehicle Exits to the Radial Road (FIG. 4)>In both the first and second embodiments, affirmative determinations are made in steps S10 and S30, and a negative determination is made in step S40. Accordingly, steps S100 to S120 are performed such that a target planned vehicle speed Vpt of the vehicle 102 for travel on the radial road is set and transition vehicle speed control during transition travel from the circulatory roadway to the radial road is executed so that the vehicle speed V of the vehicle gradually approaches the target planned vehicle speed Vpt.

### Case Where the Width of the Circulatory Roadway Is Equal to the Width of Two Lanes and the Vehicle Exits to the Radial Road (FIGS. 5 and 6)

In both the first and second embodiments, affirmative determinations are made in steps S10, S30 and S40.

Accordingly, in the first embodiment (FIG. 2), in step S50, it is determined whether or not the vehicle 102 is traveling in the region corresponding to the width of the outermost one lane of the circulatory roadway. In the second embodiment (FIG. 3), in step S60, it is determined whether or not the distance Le from the reference position of the vehicle 102 to the exit to the radial road is equal to or smaller than the reference distance Lec.

When the vehicle exits from the circulatory roadway to the radial road, an affirmative determination is made in step S50 or S60, and steps S100 to S120 are performed. Accordingly, the target planned vehicle speed Vpt of the vehicle 102 for travel on the radial road is set, and transition vehicle speed control during transition travel from the circulatory roadway to the radial road is executed so that the vehicle speed V of the vehicle gradually approaches the target planned vehicle speed Vpt.

When the vehicle does not exit from the circulatory roadway to the radial road, a negative determination is made in step S50 or S60, and steps S70 to S90 are performed. Accordingly, the target vehicle speed Vct in accordance with the circulatory roadway is set, and speed control during circular travel is executed so that the vehicle speed V of the vehicle 102 becomes the target vehicle speed Vct.

As is apparent from the above description, according to the first and second embodiments, when the vehicle 102 is traveling through the roundabout 114 (S10) and is determined, based at least on an object information acquired by the object information acquisition device 15, to be oriented toward a radial road 110 connected to a circulatory roadway 112 of the roundabout (S30), the transition vehicle speed control is executed (S100-S120). In the transition vehicle speed control, the target planned vehicle speed Vpt in accordance with the radial road is determined, and the vehicle speed V of the vehicle is controlled so that the vehicle speed gradually approaches the target planned vehicle speed.

Accordingly, as compared with a conventional case in which it is determined whether or not the vehicle is exiting from the roundabout based on the steering angle, the yaw rate of the vehicle and the like, it is possible to reduce the likelihood that exiting from the roundabout is erroneously determined and that inappropriate transition vehicle speed control is performed.

Further, according to the first and second embodiments, it is determined that the vehicle is oriented toward the radial road (S30) when a radial road 110 exists in front of the vehicle 102 and an angle φ formed between a straight-ahead direction of the vehicle and a direction along the radial road is equal to or smaller than the reference angle φc.

Accordingly, as compared to where only one of the following is used as a determination condition: that a radial road exists in front of the vehicle, and that an angle formed between a straight-ahead direction of the vehicle and a direction along the radial road is equal to or smaller than the reference angle, it is possible to more accurately determine whether or not the vehicle is oriented toward the radial road.

In particular, according to the modified example, in addition to the fact that a radial road exists in front of the vehicle and an angle formed between a straight-ahead direction of the vehicle and a direction along the radial road is equal to or smaller than the reference angle, when a steering angle is equal to or greater than the reference steering angle toward the side of the radial road, it is determined that the vehicle is oriented toward the radial road.

Accordingly, as compared to where the fact that the steering angle is equal to or greater than the reference steering angle toward the side of the radial road is not taken into consideration, it is possible to more reliably reduce the likelihood that exiting from the roundabout is erroneously determined and that inappropriate transition vehicle speed control is performed, by accurately determining whether or not the vehicle is oriented toward the radial road.

Furthermore, according to the first embodiment, even when it is determined that the vehicle 102 is oriented toward the radial road 110 (S30), if the width of the circulatory roadway 112 is equal to or greater than the width of two lanes (S40) and the vehicle is not traveling in the region corresponding to the width of the outermost one lane of the circulatory roadway (S50), the transition vehicle speed control is not executed. Therefore, it is possible to prevent unnecessary transition vehicle speed control from being executed and the vehicle speed from being inappropriately controlled.

Furthermore, according to the second embodiment, when the width of the circulatory roadway 112 is equal to or greater than the width of two lanes (S40), the transition vehicle speed control is executed (S100-S120) when the vehicle 102 is oriented toward the radial road 110 (S30) and a distance Le between the vehicle and an exit to the radial road is equal to or smaller than the reference distance Lec (S60). Accordingly, as compared to where the distance between the vehicle and the exit to the radial road is not taken into consideration, it is possible to reduce the likelihood that exiting from the roundabout is erroneously determined and that inappropriate transition vehicle speed control is performed, by accurately determining whether or not the vehicle exits from the roundabout.

Although the present disclosure has been described in detail with reference to specific embodiments, it will be apparent to those skilled in the art that the present disclosure is not limited to the above-described embodiments, and various other embodiments are possible within the scope of the present disclosure.

For example, in the above first and second embodiments, the travel control apparatus 100 executes radar cruise control, determines a target vehicle speed Vnt in accordance with a road on which the vehicle is traveling, and controls the vehicle speed V of the vehicle so that the vehicle speed becomes the target vehicle speed. However, the travel control apparatus of the present disclosure may be applied to an autonomous driving control that controls the vehicle so as to automatically travel along a target route and controls the vehicle speed V of the vehicle so that the vehicle speed becomes a target vehicle speed in accordance with the road. Furthermore, in an adaptive cruise control that executes constant-speed travel control and preceding-vehicle following control, control by the travel control apparatus of the present disclosure may be executable instead of the constant-speed travel control.

In the first embodiment, in step S50, it is determined whether or not the vehicle 102 is traveling in the region corresponding to a width of the outermost one lane of the circulatory roadway, and when an affirmative determination is made, the transition vehicle speed control is executed. In the second embodiment, in step S60, it is determined whether or not a distance Le from the reference position of the vehicle 102 to an exit to a radial road is equal to or smaller than the reference distance Lec, and when an affirmative determination is made, the transition vehicle speed control is executed. However, the transition vehicle speed control may be executed when it is determined that the vehicle is traveling in the region corresponding to the width of the outermost one lane of the circulatory roadway and that the distance Le from the reference position of the vehicle to the exit to the radial road is equal to or smaller than the reference distance Lec.

Furthermore, in FIGS. 4 to 6, diagrams for explaining operations of the embodiments in a country with right-hand traffic are shown. However, the travel control apparatus of the present disclosure may also be implemented in a country with left-hand traffic.

What is claimed is:

1. A vehicle travel control apparatus comprising:
a road information acquisition device configured to acquire information on a road on which a vehicle is traveling; and
an electronic control unit configured to determine, based on road information acquired by the road information acquisition device, a target vehicle speed in accordance with the road on which the vehicle is traveling, and to control a vehicle speed of the vehicle so that the vehicle speed becomes the determined target vehicle speed, wherein
the vehicle travel control apparatus further comprises an object information acquisition device configured to acquire object information around the vehicle, and
the electronic control unit is configured such that, when the vehicle is traveling through a roundabout and is determined, based at least on object information acquired by the object information acquisition device, to be oriented toward a radial road connected to a circulatory roadway of the roundabout, the electronic control unit determines a target planned vehicle speed in accordance with the radial road and executes transition vehicle speed control for controlling the vehicle speed of the vehicle such that the vehicle speed gradually approaches the target planned vehicle speed.

2. The vehicle travel control apparatus according to claim 1, wherein the electronic control unit is configured to determine that the vehicle is oriented toward a radial road when the radial road exists in front of the vehicle and an angle formed between a straight-ahead direction of the vehicle and a direction along the radial road is equal to or smaller than a reference angle.

3. The vehicle travel control apparatus according to claim 2, wherein the electronic control unit is configured to determine that the vehicle is oriented toward the radial road when the radial road exists in front of the vehicle, the angle formed between the straight-ahead direction of the vehicle and the direction along the radial road is equal to or smaller than the reference angle, and a steering angle is equal to or greater than a reference steering angle toward a side of the radial road.

4. The vehicle travel control apparatus according to claim 1, wherein the electronic control unit is configured such that, even when the electronic control unit determines that the vehicle is oriented toward the radial road, if a width of the circulatory roadway is equal to or greater than a width of two lanes and the vehicle is not traveling in a region corresponding to a width of an outermost one lane of the circulatory roadway, the transition vehicle speed control is not executed.

5. The vehicle travel control apparatus according to claim 1, wherein the electronic control unit is configured such that, when a width of the circulatory roadway is equal to or greater than a width of two lanes, the transition vehicle speed control is executed when the electronic control unit determines that the vehicle is oriented toward the radial road and a distance between the vehicle and an exit to the radial road is equal to or smaller than a reference distance.
